(19) United States
(12) Patent Application Publication
(10) Pub. No.: US 2012/0179333 A1
(43) Pub. Date: Jul. 12, 2012

(54) Method for Influencing the Steering Torque in a Vehicle Steering System

(76) Inventors: Adrian Thomys, Murr (DE); Erik Lesser, Steinheim (DE)

(21) Appl. No.: 13/377,246

(22) PCT Filed: Apr. 20, 2010
(86) PCT No.: PCT/EP2010/055179

§ 371 Date: Mar. 27, 2012

(30) Foreign Application Priority Data
Jun. 17, 2009 (DE) 102009026997.5

(51) Int. Cl. B62D 6/00

(52) U.S. Cl. 701/41

(57) ABSTRACT

In a method for influencing the steering torque in a vehicle-steering system, in the event that the coefficient of friction between at least one vehicle wheel and the road surface undershoots a limit value, the torque generated in a device for steering-force assistance is varied in such a way that a steering motion in at least one steering direction is opposed by increased resistance.

### BACKGROUND OF THE INVENTION

1. Field of the Invention

The present invention relates to a method for influencing the steering torque in a vehicle-steering system provided with a device for steering-force assistance, via which a supporting torque is able to be generated in the steering system.

2. Description of Related Art

From published German patent application document DE 10 2005 003 177 A1, it is known to use an actuator system to apply a countersteering torque in a vehicle-steering system if the vehicle strays from the setpoint lane, in order to thereby induce the driver to correct the steering angle and to return the vehicle to the setpoint lane. To implement the method, first the setpoint lane as well as the actual vehicle park position relative to the setpoint lane are determined with the aid of a camera or a radar system. When the vehicle's actual position deviates from the setpoint lane, the countersteering torque is generated in order to assist the driver.

From published German patent application document DE 195 43 928 A1, a method for the early detection of aquaplaning of a vehicle tire on wet road surfaces is known, in which the wheel speed is detected and the frequency spectrum of the wheel speeds is analyzed. Hydroplaning occurs when an evaluation in the frequency range determines detuning of the rotary natural frequencies, i.e., a deviation from setpoint values.

### BRIEF SUMMARY OF THE INVENTION

An objective of the present invention is reducing the accident risk in a suddenly occurring reduction in the coefficient of friction, especially in the case of aquaplaning.

The method according to the present invention is used in vehicles having a vehicle-steering system which is equipped with a device for steering-force assistance. A device for steering-force assistance preferably is an electric servo motor or control motor (EPS), but other devices for steering-force assistance are also usable within the scope of the present invention, provided they are able to generate an adjustable supporting torque.

In general, such devices for steering-force assistance generate a supporting torque which is superposed to the hand torque input by the driver via the steering wheel, in order to reduce the steering forces to be applied by the driver for steering purposes. According to the present invention, the device for steering-force assistance is utilized to influence the steering motion of the driver in the event of a sudden drop in the coefficient of friction. Such a drop in the coefficient of friction between the vehicle tire and road surface occurs in particular in aquaplaning situations when the tire begins to acquaplane and a water film is situated between one or several tire(s) and the road surface. However, the sudden reduction in the coefficient of friction may also be due to other conditions such as the presence of ice or snow on the road surface.

If these preconditions are present, then the torque generated in the device for steering-force assistance in the function according to the present invention is manipulated in such a way that the resistance to a steering motion is increased in at least one steering direction. This lets the driver know that he should execute a steering motion in a preferred direction or that he should refrain from a steering motion in the opposite direction. If there is an intention on the part of the driver to execute a steering motion that would heighten the currently existing state of danger, in particular a motion that would lead to instability, then this steering direction is opposed by increased resistance. For example, in an aquaplaning situation while cornering, it is useful to at least not increase the steering wheel angle any further, so that, through an application via the device for steering-force assistance, increased steering resistance to a steering angle that increases steering-wheel angle is produced.

The function according to the present invention may also be used to induce the driver to correct a steering angle. In this case, the countersteering torque generated by the device for steering-force assistance during cornering not only opposes a further increase in the steering angle, but the countersteering torque is also maintained when no change occurs in the steering angle, which the driver perceives through the steering behavior, so that the driver will try to yield to the effect of the countersteering torque until the desired setpoint steering angle has been attained.

If the vehicle has already left the setpoint trajectory on account of greatly reduced friction, then it may be useful to bring the steerable wheels of the vehicle into the initial position at a steering angle equal to zero, in an effort to achieve a significant increase in the forces acting on the tires as quickly as possible and to reestablish the driving and steering capability of the vehicle. A corresponding countersteering torque function, which is applied via the device for steering-force assistance, is able to induce the driver to adopt this driving behavior.

However, for practical purposes, the magnitude of the applied countersteering torque is restricted in any event to allow the driver to override the countersteering torque.

The manipulation of the device for steering-force assistance may also extend to a reduction of the supporting torque by which the steering motion of the driver is supported. In this case as well, the driver perceives a change in the torque generated by the device for steering-force assistance, which may induce the driver to correct the steering angle.

In the event that the actual steering angle matches the setpoint steering angle, no correction by the driver is required. Instead, it suffices to adjust the torque generated in the device for steering-force assistance in such a way that increased resistance in the steering wheel is felt only in case of a steering motion, but not if the steering angle stays unchanged. For practical purposes, this countersteering torque is generated in a steering motion in both steering directions. The driver notices the countersteering torque only when the driver wishes to adjust the steering wheel from the current steering-wheel position to the one or the other direction. Thus, bilateral damping of the steering motion takes place.

If necessary, the different functionalities are also combinable. For example, in the case of an incorrect wheel steering angle position it may be useful to first build up a supporting torque via the device for steering-force assistance, which induces the driver to correct the steering angle. In so doing, a supporting torque which is oriented in the desired steering-angle position is generated. As soon as the desired steering angle position has been attained, a bilateral torque which opposes a deflection in both directions from the current steering-wheel position is generated via the device for steering-force assistance; if the instantaneous steering-angle position is maintained, no or only a negligible torque is generated via the device for steering-force assistance.

For practical reasons, the method according to the present invention runs in a closed-loop or control device in the vehicle, which either is part of the vehicle steering system or which communicates with it.

According to another useful implementation, the vehicle is equipped with an electronic stability program (ESP), which, as a driver-assistance system, automatically implements a stabilizing braking intervention in situations that are critical in terms of driving dynamics. The sensor array of the ESP system may be used for executing the method according to the present invention, especially for ascertaining whether an aquaplaning situation is at hand.

### BRIEF DESCRIPTION OF THE DRAWINGS

FIG. 1 shows a schematic illustration of a steering system in a vehicle, having an electric servo motor via which a supporting torque is able to be generated in the steering system.

FIG. 2 shows a flow chart illustrating the individual method steps for implementing the method.

### DETAILED DESCRIPTION OF THE INVENTION

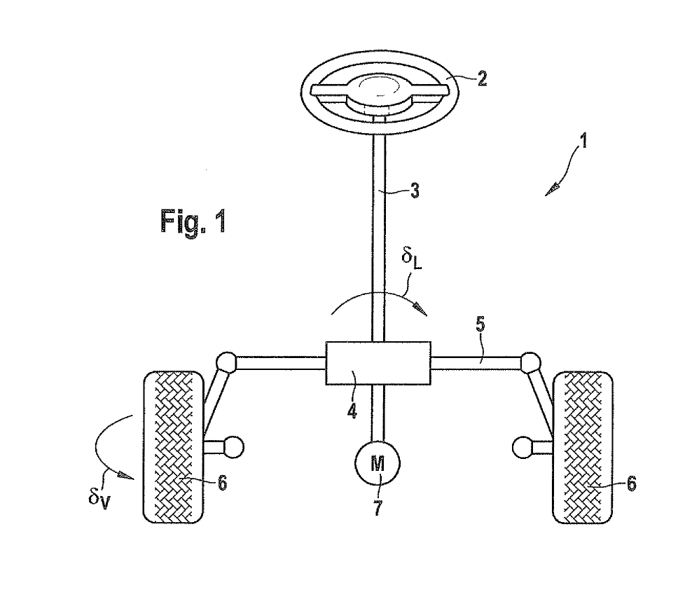

FIG. 1 shows a motor vehicle, which includes a steering wheel 2, a steering spindle 3, a steering gear 4, a steering rack 5, as well as an electric servo motor 7 (electric power steering—EPS). Via steering wheel 2, the driver specifies a steering angle δ_{L}, which is transmitted, via steering spindle 3 and gear 4 as well as steering rack 5, to steerable front wheels 6, where a wheel steering angle δ_{V} comes about.

In order to boost the hand torque exerted by the driver on steering wheel 2, a supporting torque is fed into steering system 1 in electric servo motor 7 via steering gear 4. Servo motor 7 is implemented as electric motor. Servo motor 7 is controlled via actuating signals from a closed-loop or control device which is part of steering system 1 or a driver-assistance system, e.g., an ESP system (electronic stability program).

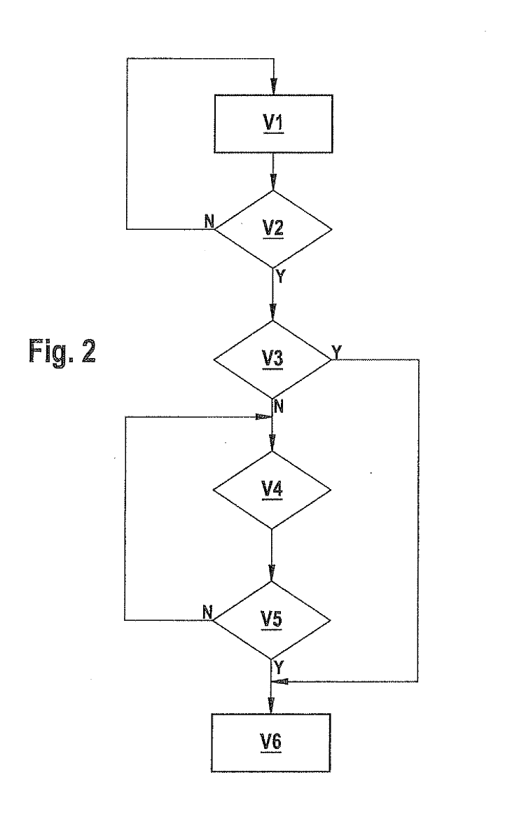

FIG. 2 shows a flow chart for implementing the method, which method is meant to reduce the accident risk in the event of aquaplaning. To begin with, in a first method step V1, a series of data acquired by sensors is analyzed and used as basis for inferring a current aquaplaning situation. These data preferably come from the sensor system of an ESP system located in the vehicle. For example, wheel slips, brake pressures as well as vehicle state variables describing the linear and transverse dynamics of the vehicle, especially linear and transverse accelerations, as well as the yaw rate are taken into account. These variables may be analyzed according to a relationship known per se, a characteristic quantity indicating aquaplaning being ascertained in the process. In the next method step V2, this characteristic quantity is queried for the presence of an aquaplaning situation. If it is determined in method step V2 that no aquaplaning situation exists as yet, in which the coefficient of friction between at least one tire of the vehicle and the road surface is reduced significantly, then a return to method step 1 takes place following the No-branching (“N”), and a new check for aquaplaning is implemented at cyclical intervals.

If the query in method step V2 indicates that an aquaplaning situation must be assumed, then the Yes-branching (“Y”) is followed by next method step V3 in which a query takes place as to whether the vehicle is currently in a cornering situation. This is checked on the basis of the steering angle by querying whether the current steering angle is equal to zero. If this is not the case, then the method continues with next method step V4; in such a case, cornering is taking place.

In method step V4, a unilaterally acting supporting torque is generated by actuating the device for steering-force assistance, which supporting torque is supplied to the steering system and is perceivable by the driver via the steering wheel. The supporting torque points in the direction of the steering wheel's initial position, in which the steering angle is equal to zero. The support via the supporting torque lasts until the steering angle assumes the desired setpoint value, which is queried in method step 5.

In cases where the actual steering angle does not yet match the setpoint steering angle, the query according to V5 is followed by a return to method step V4 after the No-branching, and a supporting torque, which acts on the steering wheel in the direction of the initial position of the steering wheel, continues to be generated. Once the desired steering angle position has been attained, and following the Yes-branching, the method continues with next method step V6, in which a bilateral, damping torque is generated via the device for steering-force assistance, which counteracts a steering angle position in both steering directions. This is meant to ensure that the current steering angle value is maintained.

Method step V6 is also reached directly, skirting method steps V4 and V5, via the query according to method step V3 if it is determined there that the steering angle assumes the initial position. In such a case, the actual position of the steering angle corresponds to the setpoint position, and a torque which maintains the current steering-angle position and is active only in deflections is generated in method step V6 in the afore-described manner.

1-12. (canceled)

13. A method for influencing a steering torque in a vehicle-steering system having a device for steering-force assistance, comprising:
in the event the coefficient of friction between at least one vehicle wheel and the road surface falls below a predetermined limit value, varying the torque generated in the device for steering-force assistance in such a way that a steering motion in at least one steering direction is opposed by increased resistance.

14. The method as recited in claim 13, wherein the torque generated in the device for steering-force assistance is a countersteering torque which opposes the steering motion.

15. The method as recited in claim 14, wherein, during cornering, the countersteering torque is directed counter to further steering-wheel deflection.

16. The method as recited in claim 14, wherein the countersteering torque is in opposition to a steering angle change in both steering directions.

17. The method as recited in claim 13, wherein the torque generated in the device for steering-force assistance is a supporting steering torque which supports the steering motion in one steering direction.

18. The method as recited in claim 17, wherein the supporting steering torque which supports the steering motion in one direction is reduced in the event of aquaplaning

19. The method as recited in claim 14, wherein the method is implemented in the event of aquaplaning

20. The method as recited in claim 19, wherein aquaplaning is detected by an electronic stability program in the vehicle.

21. A control device for influencing a steering torque in a vehicle-steering system having a device for steering-force assistance, comprising:
means for varying, in the event the coefficient of friction between at least one vehicle wheel and the road surface falls below a predetermined limit value, the torque generated in the device for steering-force assistance in such a way that a steering motion in at least one steering direction is opposed by increased resistance.

22. The control device as recited in claim 21, wherein the control device is part of the vehicle-steering system.

23. The control device as recited in claim 22, wherein the device for steering-force assistance includes an electric servo motor.
